(19) United States
(12) Patent Application Publication
(10) Pub. No.: US 2011/0075868 A1
(43) Pub. Date: Mar. 31, 2011

(54) ELECTROSTATIC SPEAKER

(75) Inventor: Yasuaki Takano, Kikugawa-shi (JP)

(73) Assignee: Yamaha Corporation, Hamamatsu-shi (JP)

(21) Appl. No.: 12/891,670

(22) Filed: Sep. 27, 2010

(30) Foreign Application Priority Data
Sep. 30, 2009 (JP) 2009-228543

(51) Int. Cl. H04R 19/00

(52) U.S. Cl. 381/191

(57) ABSTRACT

An electrostatic speaker is constituted of a diaphragm and an electrode which are disposed opposite to and/or slightly distanced from each other. A first conductive layer is formed on a first surface of the diaphragm whilst a second conductive layer is formed on a second surface of the diaphragm, wherein the first surface is disposed opposite to the second surface. A holding member or installation equipment holds a holding region formed at a predetermined position of the main body of an electrostatic speaker. The first conductive layer is formed on the first surface of the diaphragm while circumventing the holding region, and the second conductive layer is formed on the second surface of the electrode while circumventing the holding region. A through-hole can be formed to run through the diaphragm and electrode in the holding region of an electrostatic speaker.

### BACKGROUND OF THE INVENTION

1. Field of the Invention

The present invention relates to electrostatic speakers (or capacitor speakers) constituted of parallel planar electrodes and diaphragms.

The present application claims priority on Japanese Patent Application No. 2009-228543, the content of which is incorporated herein by reference.

2. Description of the Related Art

Patent Document 1 discloses an electrostatic speaker in which a diaphragm having conductivity is slightly distanced from and interposed between a pair of fixed electrodes having conductivity, which are disposed opposite to each other. Patent Document 2 discloses a planar speaker in which a pair of planar electrodes is disposed in proximity to the surface and backside of a diaphragm (i.e. a thin-film member) via damping members.

Patent Document 1: Japanese Patent Application Publication No. 2007-274341

Patent Document 2: Japanese Patent Application Publication No. 2008-54154

The technologies of Patent Documents 1 and 2 may not always demonstrate a normal functionality as an electrostatic speaker when adjacent conductive layers unexpectedly conduct to each other due to a wrong installation of an electrostatic speaker. Even when an electrostatic speaker is installed with a holding member tightly holding end portions thereof, the electrostatic speaker may not function normally due to a short-circuiting of adjacent conductive layers under a high pressure applied to end portions thereof. Even when an electrostatic speaker is installed with a holding member having conductivity (e.g. a screw or hook) being inserted into a through-hole (which runs through the electrostatic speaker), the electrostatic speaker may not function normally due to a short-circuiting of adjacent conductive layers (which are partially exposed on the interior wall of a through-hole) being pressed by a holding member, In addition, a high pressure applied to the periphery of a through-hole may cause a short-circuiting of adjacent conductive layers, thus disturbing a normal function of an electrostatic speaker.

### SUMMARY OF THE INVENTION

It is an object of the present invention to provide an electrostatic speaker which does not cause a short-circuiting of adjacent conductive layers regardless of installation using various types of holding members.

An electrostatic speaker of the present invention is constituted of a diaphragm in which a first conductive layer is formed on a first surface, and an electrode in which a second conductive layer is formed on a second surface. The diaphragm is disposed opposite to and/or slightly distanced from the electrode in such a way that the first surface is disposed opposite to the second surface. A holding region is formed on the main body of an electrostatic speaker in relation to the first surface of the diaphragm and the second surface of the electrode. The first conductive layer circumvents the holding region of the first surface whilst the second conductive layer circumvents the holding region of the second surface.

In the above, the holding region is formed along a predetermined edge of the main body of an electrostatic speaker. That is the holding region is formed on the first surface along the predetermined edge whilst the holding region is formed on the second surface along the predetermined edge.

In addition, a through-hole can be formed to run through the diaphragm and the electrode. The holding region of the first surface is formed in the periphery of a through-hole running through the diaphragm, whilst the holding region of the second surface is formed in the periphery of a through-hole running through the electrode,

The installation equipment is adapted to the electrostatic speaker in such a way that a holding member holds the holding region of the electrostatic speaker, thus installing the electrostatic speaker at a predetermined position (e.g. a wall surface). The present invention guarantees the normal functionality of an electrostatic speaker irrespective of installation measures. Even when a through-hole of an electrostatic speaker is hung at a predetermined position via a holding member, the present invention guarantees normal functionality of the electrostatic speaker.

### BRIEF DESCRIPTION OF THE DRAWINGS

These and other objects, aspects, and embodiments of the present invention will be described in more detail with reference to the following drawings.

FIG. 1 is a perspective view showing an exterior appearance of an electrostatic speaker according to a first embodiment of the present invention.

FIG. 2 is a cross-sectional view of the electrostatic speaker of FIG. 1.

FIG. 3 is an exploded perspective view of the electrostatic speaker of FIG. 1,

FIG. 4 is an electric circuit showing an electronic configuration of the electrostatic speaker.

FIG. 5 is a perspective view showing an example of installation equipment including a suspension-type holding member for holding the electrostatic speaker of FIG. 1.

FIG. 6 is a perspective view showing an exterior appearance of an electrostatic speaker according to a second embodiment of the present invention.

FIG. 7 is a cross-sectional view of the electrostatic speaker of FIG. 6.

FIG. 8 is an exploded perspective view of the electrostatic speaker of FIG. 6.

FIG. 9 is a perspective view showing an example of installation equipment including a suspension-type holding member for holding the electrostatic speaker of FIG. 6.

### DESCRIPTION OF THE PREFERRED EMBODIMENTS

The present invention will be described in further detail by way of examples with reference to the accompanying drawings.

### First Embodiment

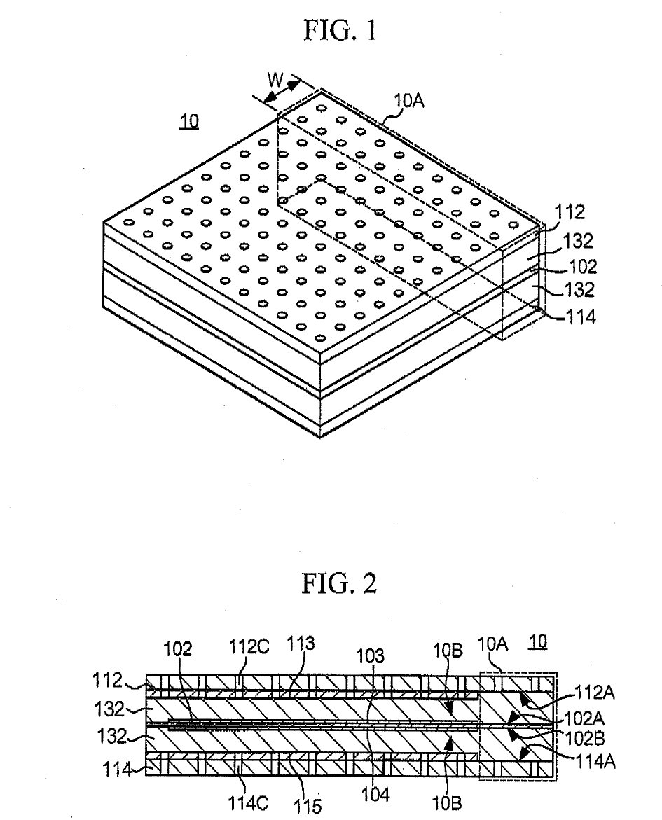

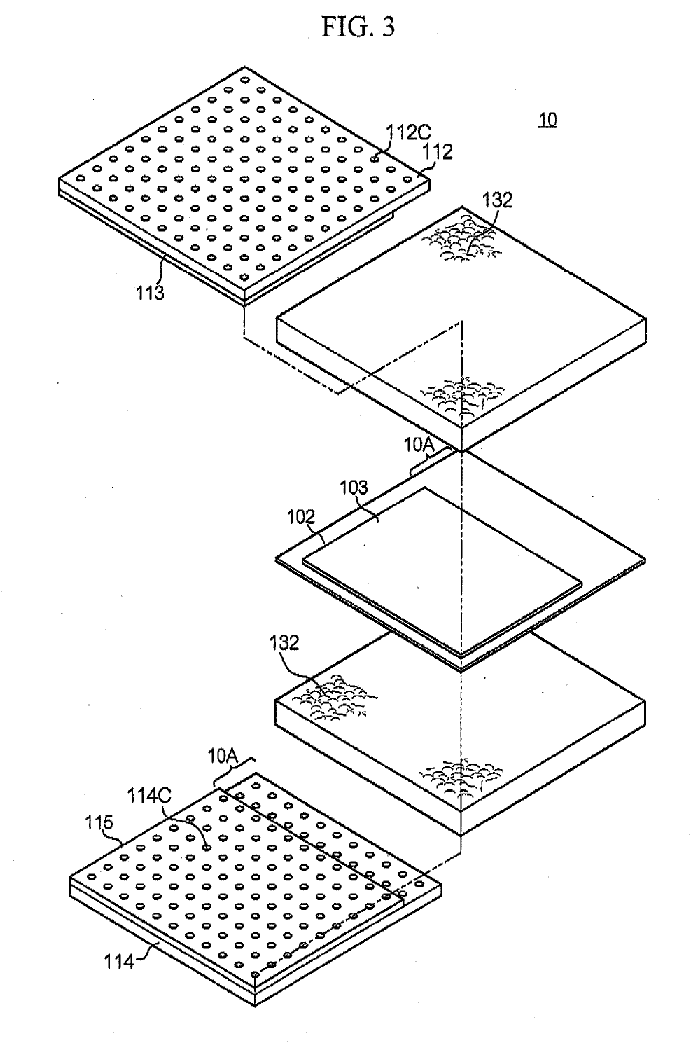

FIG. 1 is a perspective view showing an exterior appearance of an electrostatic speaker 10 according to a first embodiment of the present invention, FIG. 2 is a cross-sectional view of the electrostatic speaker 10. FIG. 3 is an exploded perspective view of the electrostatic speaker 10.

The electrostatic speaker 10 is constituted of an electrode 112, a diaphragm 102, an electrode 114, and a pair of cushion materials 132. The electrostatic speaker 10 has a laminated structure sequentially laminating the electrode 112 (i.e. an uppermost portion), the cushion material 132, the diaphragm 102, the cushion material 132, and the electrode 114 (i.e. a lowermost portion), which are mutually connected together via tapes or bonds (or adhesives). The electrostatic speaker 10 has an integral structure including these constituent elements as shown in FIG. 1. The diaphragm 102, the electrodes 112 and 114 are composed of thin films having flexibility. In addition, the diaphragm 102, the electrodes 112 and 114 have rectangular planar shapes. For example, the diaphragm 102, the electrodes 112 and 114 are composed of PET (i.e. polyethylene terephthalate) or PP (i.e. polypropylene). A plurality of apertures 112C is formed in the electrode 112 with predetermined spacing therebetween, while a plurality of apertures 114C is formed in the electrode 114 with predetermined spacing therebetween.

A main body of the electrostatic speaker 10 has a holding region 10A, which is held by a holding member (not shown) in an installation of the electrostatic speaker 10. The holding region 10A is laid along an edge of the main body of the electrostatic speaker 10. That is, the holding region 10A having a width W is formed along one side of the electrostatic speaker 10 having a rectangular shape.

The diaphragm 102 is sandwiched between the electrodes 112 and 114 via the cushion materials 132 with one end portion thereof being held between the electrodes 112 and 114, One cushion material 132 is interposed between the diaphragm 102 and the electrode 112, while the other cushion material 132 is interposed between the diaphragm 102 and the electrode 114. The cushion materials 132 have insulating property, air permeability, and elasticity. The cushion materials 132 are composed of compressed cottons. An internal space 10B which allows for an upper-side vibration of the diaphragm 102 is secured between the diaphragm 102 and the electrode 112, while another internal space 10B which allows for a lower-side vibration of the diaphragm 102 is secured between the diaphragm 102 and the electrode 114. It is possible to insert a spacer between the diaphragm 102 and the electrode 112, thus securing the internal space 10B therebetween. In addition, it is possible to insert a spacer between the diaphragm 102 and the electrode 114, thus securing the internal space 10B therebetween.

A vibrating portion of the diaphragm 102 other than one edge thereof has a shape and size which can be stored inside the internal space 10B. The vibrating portion of the diaphragm 102 is disposed approximately at an intermediate position of the internal space 10B in a vertical direction and interposed between the electrodes 112 and 114. An upper surface 102A of the diaphragm 102 is disposed opposite to a lower surface 112A of the electrode 112 via the internal space 10B which is sufficiently large to accept an upper-side vibration of the diaphragm 102. A lower surface 102B of the diaphragm 102 is disposed opposite to an upper surface 114A of the electrode 114 via the internal space 10B which is sufficiently large enough to accept a lower-side vibration of the diaphragm 102.

A conductive layer 103 is formed on the upper surface 102A of the diaphragm 102, while a conductive layer 104 is formed on the lower surface 102B of the diaphragm 102. A conductive layer 113 is formed on the lower surface 112A of the electrode 112, while a conductive layer 115 is formed on the upper surface 114A of the electrode 114. The conductive layers 103, 104, 113, and 115 are formed on the surfaces 102A, 102B, 112A, and 114A in such a way that conductive metals are deposited on these surfaces or conductive coatings are applied onto these surfaces.

As described above, the holding region 10A is formed along one edge of the electrostatic speaker 10 with the predetermined with W; that is, the holding region 10A having the width W is formed along one edge of the upper surface 102A of the diaphragm 102 and is also formed along one edge of the lower surface 102B of the diaphragm 102. In addition, the holding region 10A having a width W is formed along one edge of the lower surface 112A of the electrode 112 and is further formed along one edge of the upper surface 114A of the electrode 114.

The electrostatic speaker 10 is designed to satisfy at least one of design choices (a) and (b).

(a) The conductive layer 103 is formed to bypass the holding region 10A on the upper surface 102A of the diaphragm 102.
(b) The conductive layer 113 is formed to bypass the holding region 10A on the lower surface 112A of the electrode 112.

Specifically, the conductive layer 103 is not formed in the holding region 10A on the upper surface 102A of the diaphragm 102, so that the conductive layer 103 bypasses the holding region 10A of the upper surface 102A. The conductive layer 113 is not formed in the holding region 10A on the lower surface 112A of the electrode 112, so that the conductive layer 113 bypasses the holding region 10A of the lower surface 112A.

The electrostatic speaker 10 is designed to satisfy at least one of design choices (c) and (d).

(c) The conductive layer 104 is formed to bypass the holding region 10A on the lower surface 102B of the diaphragm 102.
(d) The conductive layer 115 is formed to bypass the holding region 10A on the upper surface 114A of the electrode 114.

That is, the conductive layer 104 is not formed in the holding region 10A on the lower surface 1028 of the diaphragm 102, so that the conductive layer 104 bypasses the holding region 10A of the lower surface 102B. The conductive layer 115 is not formed in the holding region 10A on the upper surface 114A of the electrode 114, so that the conductive layer 115 bypasses the holding region 10A of the upper surface 114.

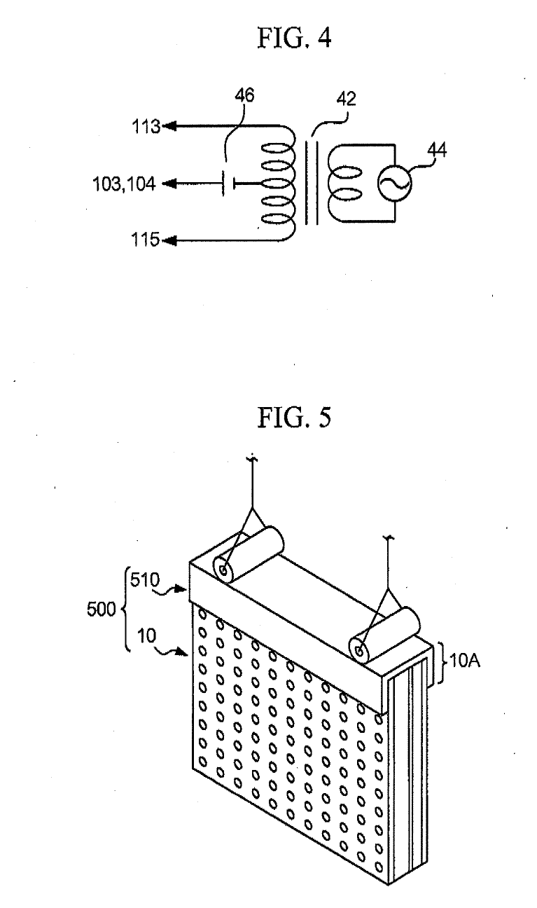

FIG. 4 is a circuit diagram showing an electronic configuration of the electrostatic speaker 10. The electrostatic speaker 10 is a push-pull electrostatic speaker including a transformer 42, an input unit 44 for inputting audio signals from an external device (not shown), and a bias power source 46 for applying a DC bias voltage to the diaphragm 102. A neutral point of the output side of the transformer 42 is connected to one terminal of the bias power source 46, while the other terminal of the bias power source 46 is connected to the conductive layers 103 and 104. One terminal of the output side of the transformer 42 is connected to the conductive layer 113, while the other terminal of the output side of the transformer 42 is connected to the conductive layer 115. Terminals of the input side of the transformer 42 are connected with the input unit 44, A voltage is applied to the conductive layers 113 and 115 in correspondence with an audio signal input into the input unit 44. When a voltage difference occurs between the conductive layers 113 and 115, an electrostatic force is exerted on the conductive layers 103 and 104, each of which is attracted toward either the conductive layer 113 or the conductive layer 115.

For example, a positive voltage is applied to the conductive layers 103 and 104, wherein a positive voltage is applied to the conductive layer 113 while a negative voltage is applied to the conductive layer 115. In this situation, the diaphragm 102 is displaced toward the conductive layer 115 in such a way that the conductive layers 103 and 104 sandwiching the diaphragm 102 are repelled by the “positively charged” conductive layer 113 while being attracted toward the “negatively charged” conductive layer 115. Alternatively, a positive voltage is applied to the conductive layers 103 and 104, wherein a negative voltage is applied to the conductive layer 113 while a positive voltage is applied to the conductive layer 115. In this situation, the diaphragm 102 is displaced toward the conductive layer 113 in such a way that the conductive layers 103 and 104 are repelled by the conductive layer 115 while being attracted toward the conductive layer 113. The diaphragm 102 is forced to vibrate as the conductive layers 103 and 104 repeat displacements toward the conductive layers 113 and 115. The diaphragm 102 vibrates to produce sound based on vibration factors (i.e. frequency, amplitude, and phase). Sound caused by the diaphragm 102 permeates at least one of the apertures 112C of the electrode 112 and the apertures 114C of the electrode 114, so that the electrostatic speaker 10 emits sound into the external space.

FIG. 5 shows an example of installation equipment 500 including a suspension-type holding member 510 for holding the electrostatic speaker 10. The electrostatics speaker 10 is suspended by the holding member 510 in such a way that the holding region 10A is directed upward and tightly held by the holding member 510. That is, the holding member 510 is limited to hold the holding region 10A of the electrostatic speaker 10, which is thus subjected to a high pressure (which is sufficient for the holding member 50 to tightly hold the holding region 10A of the electrostatic speaker 10). Since no conductive layers are formed and disposed opposite to each other in the holding region 10A of the diaphragm 102, the electrodes 112 and 114, it is possible to reliably prevent conductive layers from contacting each other irrespective of a high pressure applied to the holding region 10A. Even though the electrostatic speaker 10 is installed at a certain position while being tightly held by the holding member 510 or the like, the electrostatic speaker 10 is able to function normally. Alternatively, the electrostatic speaker 10 can be installed at a certain position by way of a through-hole formed in the holding region 10A. In this case, the electrostatic speaker 10 is able to function normally because no conductive layers are formed and disposed opposite each other in the holding region 10A of the diaphragm 102, the electrodes 112 and 114.

### Second Embodiment

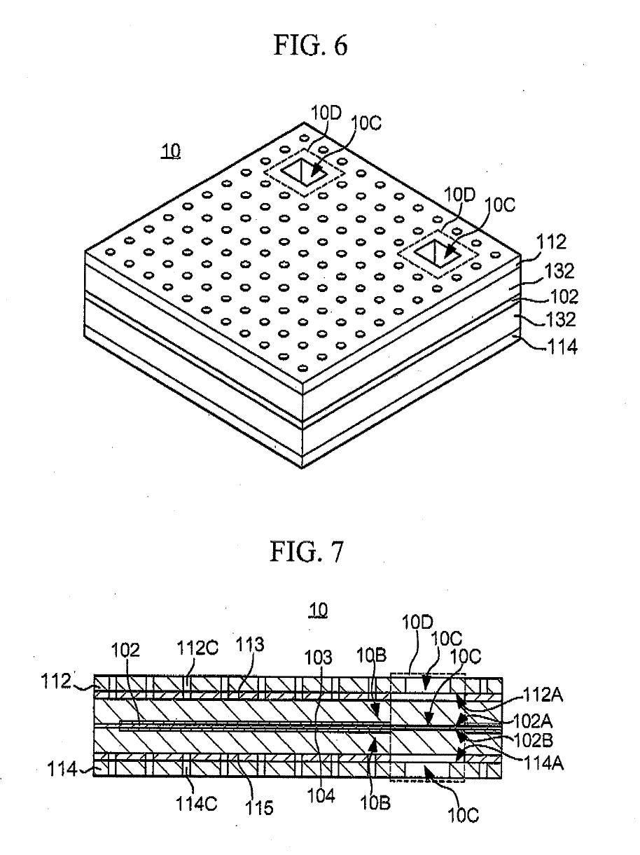

FIG. 6 is a perspective view showing the exterior appearance of the electrostatic speaker 10 according to a second embodiment of the present invention. Since the second embodiment is similar to the first embodiment, the following description refers to differences between the first and second embodiments; hence, similarities between the first and second embodiments are not discussed below.

In the second embodiment, through-holes 10C pierce through the main body of the electrostatic speaker 10 from the upper surface of the electrode 112 to the lower surface of the electrode 114, That is, the through-holes 10C run through the electrode 112, the diaphragm 102, and the electrode 114. FIG. 6 shows that the through-holes 10C are each formed in a rectangular shape in plan view. In addition, holding regions 10D are formed in proximity to the through-holes 10C in the main body of the electrostatic speaker 10. During an installation of the electrostatic speaker 10, the holding regions 10D are being held by holding members. Specifically, the holding regions 10D are formed in the periphery of the through-holes 10C. In plan view, the holding regions 10D have rectangular shapes which are lager than the rectangular shapes of the through-holes 10C.

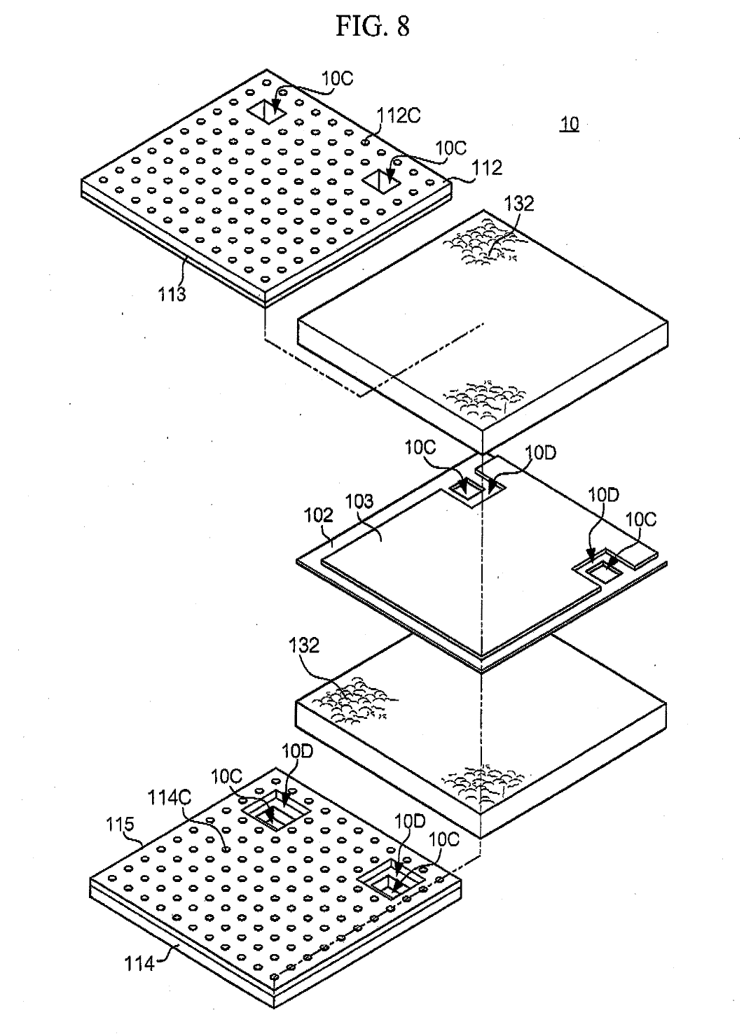

FIG. 7 is a cross-sectional view of the electrostatic speaker 10 of the second embodiment. FIG. 8 is an exploded perspective view of the electrostatic speaker 10 of the second embodiment. The holding regions 10D are formed in the periphery of the through-holes 10C in a vertical direction of the electrostatic speaker 10, so that the holding regions 10D are formed in the periphery of the through-holes 10C on the upper surface 102A of the diaphragm 102, while the holding portions 10D are formed in the periphery of the through-holes 10C on the lower surface 102E of the diaphragm 102. In addition, the holding regions 10D are formed in the periphery of the through-holes 10C on the lower surface 112A of the electrode 112, while the holding regions 10D are formed in the periphery of the through-holes 10C on the upper surface 114A of the electrode 114.

The conductive layer 103 is not formed in the holding regions 10D on the upper surface 102A of the diaphragm 102; hence, the conductive layer 103 circumvents the holding regions 10D of the upper surface 102A of the diaphragm 102. In addition, the conductive layer 104 is not formed in the holding regions 10D on the lower surface 102E of the diaphragm 102; hence, the conductive layer 104 circumvents the holding regions 10D of the lower surface 102B of the diaphragm 102.

The conductive layer 113 is not formed in the holding regions 10D on the lower surface 112A of the electrode 112; hence, the conductive layer 113 circumvents the holding regions 10D of the lower surface 112A of the electrode 112. In addition, the conductive layer 115 is not formed in the holding regions 10D on the upper surface 114A of the electrode 114; hence, the conductive layer 115 circumvents the holding regions 10D of the upper surface 114A of the electrode 114.

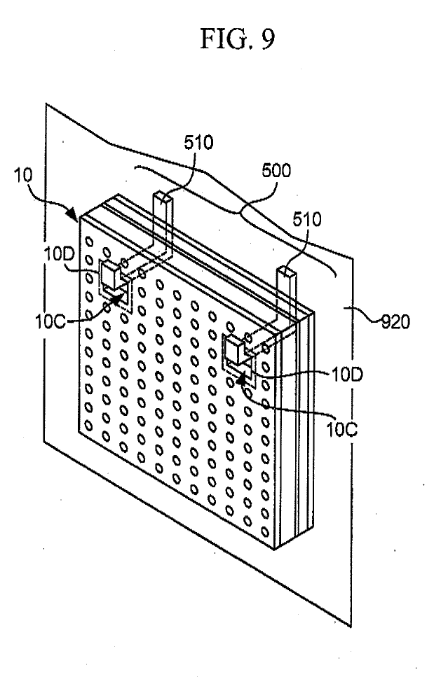

FIG. 9 is a perspective view showing an example of installation equipment 500 including the holding members 510 for holding the electrostatic speaker 10. The electrostatic speaker is suspended by the holding members 510 on a wall surface 920. The holding members 510 are fixed to the wall surface 920. As described above, the holding regions 10D are formed in the periphery of the through-holes 10C in the electrostatic speaker 10. The holding members 510 have L-shapes whose base portions are fixed to the wall surface 920 and whose projections are inserted into the through-holes 10C of the electrostatic speaker 10, so that the electrostatic speaker 10 is hung at the wall surface 920 and prevented from falling down from the wall surface 920. Since no conductive layers are formed in the holding regions 10D in the diaphragm 102, the electrodes 112 and 114, no conductive layers are exposed on the interior walls of the through-holes 10C. Even when the holding members 510 are made of conductive materials, it is possible to prevent the conductive layers 103, 104, 113, and 115 from being short-circuited in the electrostatic speaker 10. That is, the second embodiment guarantees the normal functionality of the electrostatic speaker 10 irrespective of the through-holes 10C with which the electrostatic speaker 10 is installed at a certain position.

### Variations

The present invention is not necessarily limited to the first and second embodiments, which can be further modified in various ways as follows.

(1) The structure of the electrostatic speaker 10 is not necessarily limited to the first and second embodiments. In short, the electrostatic speaker 10 needs to be configured of a diaphragm having a first conductive layer on a first surface and a substrate having a second conductive layer on a second surface. Namely, the electrostatic speaker 10 needs at least the diaphragm 102 having the conductive layer 103 on the upper surface 102A and the electrode 112 having the conductive layer 113 on the lower surface 112A. In addition, the diaphragm 102, the electrode 112 and 114 do not need conductivity in the holding region 10A and the holding regions 10D, whilst they need conductivity in other regions (other than the holding regions 10A and 10D). For example, at least one of the electrodes 112 and 114 is composed of a planar conductive cloth in which conductive materials are included in other regions (other than the holding regions 10A and 10D), whilst no conductive materials are included in the holding regions 10A and 10D.
(2) It is possible to adopt other materials other than PET and PP for use in the diaphragm 102, the electrodes 112 and 114. For example, the diaphragm 102, the electrodes 112 and 114 can be composed of synthetic resins. The cushion materials 132 need air permeability and elasticity; hence, they are not necessarily composed of compressed cottons. For example, the cushion materials 132 can be composed of ester wools. The outline shapes of the diaphragm 102, the electrode 112 and 114 are not necessarily limited to rectangular shapes. For example, the diaphragm 102, the electrodes 112 and 114 can be formed in circular shapes or polygonal shapes except for rectangular shapes. In addition, the main body of the electrostatic speaker 10 can be formed in a cylindrical shape, a conical shape, a pyramid shape, a lampshade shape, or parasol shape. In this case, it is preferable that one holding region be formed at one end of the cylindrical shape, whilst one holding region be formed at a top portion of the conical shape, the pyramid shape, the lampshade shape, or the parasol shape.
(3) It is possible to incorporate terminals with respect to the holding member 510 and the electrostatic speaker 10. The terminal of the electrostatic speaker 10 comes in contact with the terminal of the holding members 510 when the electrostatic speaker 10 is held by the holding member 510. The terminal of the electrostatic speaker 10 coupled with the terminal of the holding member 510 may serve as a power-supply terminal for supplying power to any one of the conductive layers 10, 104, 113, and 115. It is possible to incorporate a plurality of terminals (each serving as the above power-supply terminal) with respect to the electrostatic speaker 10 and the holding member 510 respectively. That is, it is possible to incorporate four power-supply terminals for supplying power to the four conductive layers 103, 104, 113, and 115 with respect to the electrostatic speaker 10 and the holding members 510 respectively.
(4) In the first embodiment, the holding region 10A is not necessarily formed along one edge of the “rectangular-shaped” electrostatic speaker 10, and the holding region 10A is not necessarily formed with a certain width. For example, the position, shape and size of the holding region 10A can be determined in conformity with the position, shape and size of the holding member 510 holding the electrostatic speaker 10. The holding member 510 does not necessarily hold the upper edge of the electrostatic speaker 10, wherein the holding member 510 can hold both the left-side and right-side edges, both the upper and lower edges of the electrostatic speaker 10, all the four corners of the electrostatic speaker 10, all the four sides of the electrostatic speaker 10, or the like. Herein, the holding region 10A needs to be set to the position at which the holding region 10A is held by the holding member 510. The length of the holding member 510 can be shorter than the length of one side of the electrostatic speaker 10. In this case, the length of the holding region 10A needs to agree with the length of the holding member 510 along a side edge of the electrostatic speaker 10 being held by the holding member 510.
(5) The electrostatic speaker 10 of the first embodiment needs to be configured such that adjacent conductive layers cannot be short-circuited in the holding region 10A. In other words, no conductivity is needed in at least one of the upper surface 102A of the diaphragm 102 and the lower surface 112A. of the electrode 112. In addition, no conductivity is needed in at least one of the lower surface 102E of the diaphragm 102 and the upper surface 114A of the electrode 114. That is, one of the conductive layers 103 and 113 is not necessarily formed in the holding region 10A. In addition, one of the conductive layers 104 and 115 is not necessarily formed in the holding region 10A. Alternatively, an insulating layer can be formed in the holding region 10A in order to cover one of the conductive layers 103 and 113 therewith. In addition, an insulating layer can be formed in the holding region 10A in order to cover one of the conductive layers 104 and 115 therewith.
(6) In the second embodiment, the through-holes 10C are not necessarily formed in rectangular shapes in plan view. The through-holes IOC can be formed in circular shapes or polygonal shapes except for rectangular shapes, The number of the through-holes 10C formed in the main body of the electrostatic speaker 10 is not necessarily limited to two. It is possible to form one through-hole 10C or three or more through-holes 10C in the main body of the electrostatic speaker 10. The holding regions 10D are not necessarily formed in rectangular shapes in plan view. The holding regions 10D can be formed in circular shapes or polygonal shapes except for rectangular shapes. The shapes of the holding regions 10D do not necessarily agree with the shapes of the through-holes 10C. The shape, position and size of the holding region 10D can be determined in conformity with the shape, position and size of the holding member 510 holding the electrostatic speaker 10. The holding region 10D can be set to a position at which the holding member 510 holds the electrostatic speaker 10.
(7) In the second embodiment, an installation measure of the electrostatic speaker 10 having the through-holes 10C is not necessarily limited to the “L-shaped” holding members 510 shown in FIG. 9. The holding member 510 can be formed in rod-like shapes (e.g. nails and stakes) which project from the wall surface 920. That is, the electrostatic speaker 10 can be hung at the rod-shapes holding members 510 with the through-holes 10C, so that the electrostatic speaker 10 is held and prevented from falling down from the wall surface 920. The electrostatic speaker 10 can be fixed to the wall surface 920 by use of screws, which are inserted into the through-holes IOC and put into the wall surface 920. In this connection, screws can be intensively fastened to certainly fix the electrostatic speaker 10 onto the wall surface 920, wherein the electrostatic speaker 10 is intensively pressed onto the wall surface 920 with screw heads at a high pressure, That is, a high pressure, which is sufficient to press and fix the electrostatic speaker 10 onto the wall surface 920, is applied to the holding regions 10D via screw heads, Since no conductive layers are formed in the diaphragm 102, the electrodes 112 and 114 in the holding region 10D, adjacent conductive layers cannot be short-circuited with a high pressure applied to the holding regions 10D. As described above, the second embodiment (and its variations) guarantees the normal functionality of the electrostatic speaker 10 even when the electrostatic speaker 10 is installed at a certain position.
(8) In the second embodiment, the electrostatic speaker 10 does not necessarily equipped with the through-holes 10C in shipment. The electrostatic speaker 10 subjected to shipment can have the holding regions 10D which do not surround the through-holes 10C. This allows users to arbitrarily form the through-holes 10C used for fixing the electrostatic speaker 10 onto the wall surface 920. Before an installation of the electrostatic speaker 10 on the wall surface 920, users may form the through-holes 10C in the holding regions 10D by use of a drill or punch in advance. Alternatively, users may form the through-holes 10C simultaneously with fixing the electrostatic speaker 10 onto the wall surface 920, wherein users may hammer nails into the holding regions 10B of the electrostatic speaker 10.
(9) It is possible to form an identification mark indicating the holding region 10A or 10D on the surface of the electrostatic speaker 10. For example, the holding region 10A or 10D can be painted in a color which differs from a color of the other region on the surface of the electrostatic speaker 10. Alternatively, the holding region 10A or 10D can be formed with a surface shape (or a texture) which differs from the texture of the other region on the surface of the electrostatic speaker 10, This helps users to easily discriminate position, shape and size of the holding member 510 holding the electrostatic speaker 10.

Lastly, the present invention is not necessarily limited to the above embodiments and variations, which can be further modified within the scope of the invention as defined in the appended claims.

What is claimed is:

1. An electrostatic speaker comprising:
a diaphragm in which a first conductive layer is formed on a first surface;
an electrode in which a second conductive layer is formed on a second surface,
wherein the diaphragm is disposed opposite to and/or slightly distanced from the electrode in such a way that the first surface is disposed opposite to the second surface; and
a holding region which is formed on the first surface of the diaphragm and the second surface of the electrode,
wherein the first conductive layer is formed on the first surface while circumventing the holding region, and the second conductive layer is formed on the second surface while circumventing the holding region.

2. The electrostatic speaker according to claim 1, wherein the holding region is formed on the first surface along a predetermined edge whilst the holding region is formed on the second surface along the predetermined edge.

3. The electrostatic speaker according to claim 1 further comprising a through-hole which runs through the diaphragm and the electrode, wherein the holding region of the first surface is formed in a periphery of the through-hole running through the diaphragm whilst the holding region of the second surface is formed in a periphery of the through-hole running through the electrode.
